(19) United States
(12) Patent Application Publication
(10) Pub. No.: US 2019/0295022 A1
(43) Pub. Date: Sep. 26, 2019

(54) Method and System for Delivering a Custom Conversion Action Based on Engagement Level

(71) Applicant: Encaptiv Corporation, Stamford, CT (US)

(72) Inventors: Shannon Malkin Daniels, Stamford, CT (US); Matthew James Daniels, Stamford, CT (US); Joshua Gaddy, Norwalk, CT (US)

(21) Appl. No.: 16/352,113

(22) Filed: Mar. 13, 2019

Related U.S. Application Data
(60) Provisional application No. 62/647,476, filed on Mar. 23, 2018.

(51) Int. Cl. G06Q 10/06; G06F 9/54; G06Q 30/02; G06F 16/438

(52) U.S. Cl. CPC G06Q 10/06315; G06F 16/4393; G06Q 30/0203; G06F 9/542

(57) ABSTRACT

A system for delivering presentations with interactive features, including polls and calls to action. The system is configured such that it can create and deliver polls and calls to action in an optimized manner, based upon feedback from a presentation viewer.

### TECHNICAL FIELD

The disclosure herein relates to systems for delivering a presentation with interactive features. Interactive features include, but are not limited to, poll questions, user feedback interfaces, and conversion actions. Systems such as the one disclosed herein can comprise different configurations of computing devices, communication networks, and features.

### BACKGROUND

Presentation delivery systems known in the art allow a presenter to deliver a presentation from a computer to a multitude of viewer computers. These systems can allow a presenter to include poll questions in the presentation and solicit answers from users. Poll questions are typically assigned to a specific slide in a presentation or created in the presentation itself. Answers to the poll questions are typically collected by the system for viewing and displaying on a specific slide or for viewing at a later time.

Additionally, known systems have mechanisms to deliver a prompt to users to complete a task. These tasks are usually created in the presentation on a specific slide of the presentation before the presentation is given.

Known systems distinctly lack flexibility and functionality to deliver poll questions and calls to action in a presentation at the most effective time and in response to a calculated level of engagement by the presentation viewers. Known systems also lack flexibility in the timing of displaying poll results. They require that the poll results be built into a particular slide in the presentation or that a separate application outside of the presentation be used to show the poll results. The system disclosed herein provides a system that includes needed flexibility in selecting and providing polling questions and calls to action. Using various data analysis techniques, the system creates and selects effective polling questions and calls to action and determines an optimal time to present them to a user to maximize the quality of data retrieved and the rate at which users complete the action called for.

### SUMMARY

Disclosed herein is one embodiment of a presentation system having a central computer that receives a plurality of presentations from one or more authors. Each presentation has a unique identifier. The presentation system also has a database in communication with the central computer for storing each presentation of the plurality of presentations. Further, the presentation system has a view computer for receiving and transmitting one of the unique identifiers to the central computer to retrieve an associated presentation from the database.

In one embodiment, the call to action is a message prompting a user of the view computer to complete a task using the view computer, the completion of the task providing data to a database.

In one embodiment, the view computer has a display for showing the associated presentation to a viewer and the view computer is configured to receive a first call to action, display the first call to action, and record input indicating an interaction with the first call to action.

In one embodiment, the central computer selects the first call to action, transmits the first call to action to the view computer, and receives the input indicating interaction with the first call to action.

In one embodiment, the view computer can also receive feedback from a user and send the feedback to the central computer. The central computer can receive feedback and select the first call to action to transmit to the view computer based upon at least the feedback from the view computer.

In one embodiment, the feedback can be produced by the user answering a feedback poll on a view computer.

In one embodiment, the feedback can be produced by the user's interaction with the view computer during the presentation and the feedback can be assigned a weight. The weight can determine a relative effect the feedback has on the selection of the first call to action.

In one embodiment, the central computer can determine when to deliver the first call to action based upon at least the feedback.

In one embodiment, the presentation system can also have an interface on the view computer for entering feedback about the associated presentation. The view computer can be configured to transmit the feedback to the central computer. The central computer can receive the feedback, store the feedback on a database together with the associated presentation, show the feedback to the author, and determine the first call to action based upon at least the feedback.

In one embodiment, the central computer can compile the feedback from a plurality of view computers, each of the view computers having a separate feedback, and modify the first call to action.

In one embodiment, the central computer can determine an individual first call to action for each of the view computers of the plurality of view computers based upon at least the feedback of each computer of the plurality of view computers and transmit each individual first call to action to each view computer.

In one embodiment, the central computer can determine an individual first call to action for each of the view computers of the plurality of view computers based upon at least the content of the presentation and transmit each individual first call to action to each view computer.

In one embodiment, the central computer can determine a second call to action based upon at least the input indicating an interaction with the first call to action.

In one embodiment, the presentation system can also have a central computer receiving a poll from the author, a database storing the poll, the view computer receiving the poll, the display on the view computer showing the poll, the interface on the view computer for entering a response to the poll, and the view computer transmitting the response to the central computer. The central computer can associate the poll with one of the unique identifiers, receive the response, store the response together with the associated presentation, show the response to the author, show the response on the display on the view computer at the command of the author and during the associated presentation, and determine the first call to action based upon at least the response.

In one embodiment, the central computer can also create the poll.

In one embodiment, the poll response can update in real time while shown on the display on the view computer.

In one embodiment, the central computer can also receive a plurality of responses, store the plurality of responses together with the associated presentation, show the plurality of responses to the author, show the plurality of responses on the display on the view computer at the command of the author and during the associated presentation, and determine the first call to action based upon at least the plurality of responses.

In one embodiment, the presentation system can also have a plurality of presentations from at least one author, each presentation of the plurality of presentations can be a segment of a composite presentation and have a unique identifier. The database can store the plurality of presentations.

The presentation computer can transmit the unique identifier to the central computer and initiate delivery of the segments of the composite presentation to the view computer. The view computer can have an interface displayed on the display of the view computer for entering feedback about the composite presentation. The central computer can receive the feedback from the view computer and, using at least the feedback, select the next segment of the composite presentation. The central computer can also show the feedback to at least one author, determine the first call to action based upon the feedback, transmit the first call to action to the view computer, and receive the input indicating interaction with the first call to action.

In one embodiment, the view computer can be a cell phone.

In one embodiment, the central computer can compile the feedback from a plurality of view computers and modify the call to action based on at least the compiled feedback.

In one embodiment, an author can submit call to action options to the central computer.

In one embodiment, the central computer of the presentation system can select a first call to action from the call to action options for each view computer of the plurality of view computers based on at least the feedback from the corresponding individual view computer of the plurality of view computers.

In one embodiment, the associated presentation can include a video.

In one embodiment, the associated presentation can include audio.

In one embodiment, the associated presentation can include images.

In one embodiment, the feedback can be displayed with the associated presentation, on the display of the view computer, in real time.

Also disclosed is one embodiment of a presentation system having a server in communication with a database storing a presentation, a presenter device accessing the presentation and having an interface for controlling the presentation, and a viewer device accessing the presentation and having an interface for submitting feedback to the presenter device. The database can have a plurality of predetermined messages for the viewer devices. The server can be configured to modify one of the predetermined messages based on at least the feedback. The server can supply a modified message to the viewer device based upon at least the feedback.

In one embodiment, the viewer device can further interact with the presentation.

In one embodiment, the interaction can include a poll.

In one embodiment, the interaction can include a question and an answer.

In one embodiment, the feedback can include viewer device engagement during the presentation.

In one embodiment, the server can send feedback to the presenter device when the presentation is displayed on the presenter device.

In one embodiment, a method is carried out by which a call to action is transmitted to a view computer. The method comprises the steps of creating a call to action, a central computer receiving a plurality of calls to action, and the central computer storing the plurality of calls to action in a digital storage. Further, the method has the steps of the central computer receiving engagement feedback from the view computer and the central computer calculating an engagement score. Additionally, the method includes the central computer receiving a command to transmit one call to action of the plurality of calls to action, the central computer selecting the one call to action based upon the engagement score, and transmitting the selected one call to action to the view computer. Further still, the method includes the view computer displaying the selected one call to action on a user interface on the view computer, the user interface accepting an input interacting with the selected one call to action, the view computer producing call to action feedback as a result of at least the input, the view computer transmitting the call to action feedback to the central computer, the central computer storing the call to action feedback in the digital storage, the central computer transmitting the call to action feedback to the presenter computer, and the call to action feedback being displayed on the presenter console.

### BRIEF DESCRIPTION OF THE DRAWINGS

FIG. 1 is a flow chart disclosing the structure and data flow of one embodiment of the presentation system.

FIG. 2 is a depiction of one embodiment of a presenter console.

FIG. 3 is a depiction of one embodiment of a user interface showing a section to take notes.

FIG. 4 is a depiction of one embodiment of a user interface showing a section to submit a question to a presenter.

FIG. 5 is a depiction of one embodiment of the method by which a call to action is delivered to a view computer.

### DETAILED DESCRIPTION

The present teachings are described more fully hereinafter with reference to the accompanying drawings, in which the present embodiments are shown. The following description is presented for illustrative purposes only and the present teachings should not be limited to these embodiments. Any computer configuration and architecture satisfying the speed and interface requirements herein described may be suitable for implementing the system and method of the present embodiments.

In compliance with the statute, the present teachings have been described in language more or less specific as to structural and methodical features. It is to be understood, however, that the present teachings are not limited to the specific features shown and described, since the systems and methods herein disclosed comprise preferred forms of putting the present teachings into effect.

For purposes of explanation and not limitation, specific details are set forth such as particular architectures, interfaces, techniques, etc. in order to provide a thorough understanding. In other instances, detailed descriptions of well-known devices, circuits, and methods are omitted so as not to obscure the description with unnecessary detail.

A system for delivering a presentation to multiple users and to encourage action from those users is disclosed herein.

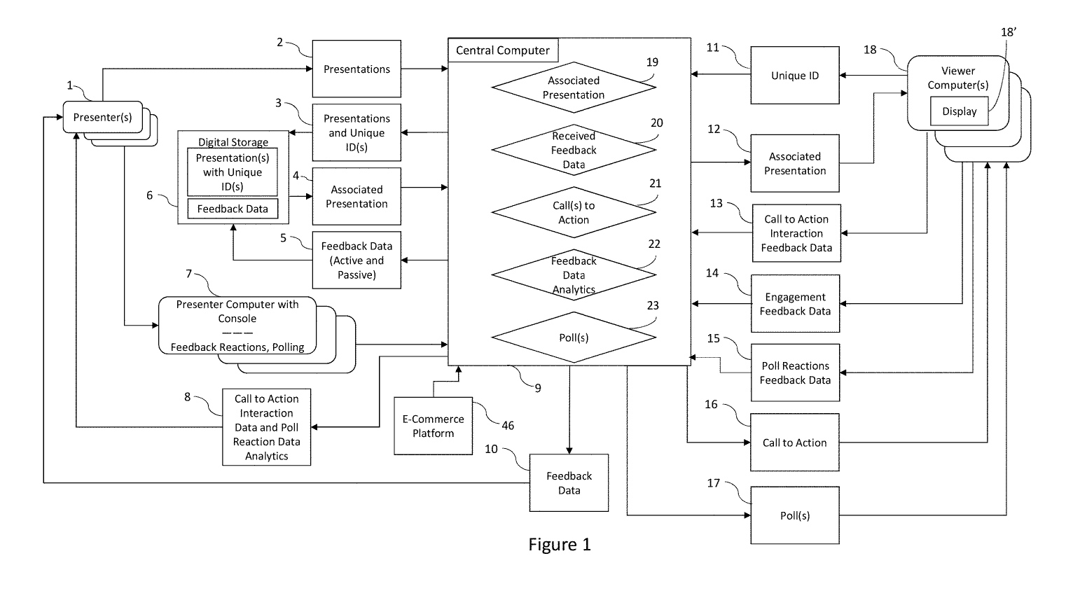

Referring to FIG. 1, the system can include a central computer 9, a view computer 18, a presenter computer 7, digital storage 6, and a communications network. Presentations can be stored on the digital storage 6 for retrieval by the central computer 9, the central computer 9 in turn sending the presentations 2 to one or more view computers 18 for display on the view computer(s) display(s) 18′. The presenter computer 7 can be used to conduct an instance of a presentation, upload presentations 2 to the system, create poll questions 17, create calls to action 16, solicit feedback 13, 14, 15 from users, and any other task commonly performed when creating and giving a presentation.

The system can include an e-commerce platform 46. The e-commerce platform 46 can contain a system by which transactions can take place between two parties. The e-commerce platform 46 can contain a system by which goods and/or service are offered to a party.

The central computer 9 can be a computer server, a personal computer, desktop computer, laptop, tablet, cell phone, or any other device capable of sending and receiving presentation data over a communications network.

The view computer 18 can be a personal computer, laptop, tablet, cell phone, or any other device capable of displaying a user interface.

The presenter computer 7 can be a personal computer, laptop, tablet, cell phone, or any other device capable of displaying a user interface.

The digital storage 6 can be any means of digitally storing data that can communicate with the other computers in the presentation system. The digital storage can be internal or external to any of the computers or servers in the system. The digital storage can include a database or a server.

The communications network can be the internet, a local area network (LAN), wide area network (WAN), wireless communication network, any combination of the preceding, or any other connection between computing devices that is capable of transmitting a signal from one device to another in order to facilitate data transfer.

A presenter 1, as defined herein, is a person or computer that directs the progression and/or design of an instance of a presentation. A presentation includes a collection of information stored as data. An instance of a presentation includes a sequential delivery of the presentation information to a viewer in an attempt to educate, inform, or entertain a viewer. A presenter 1 can conduct, create, or modify a presentation 2, poll questions 17, calls to action 16, feedback prompts, or any other aspect of a presentation.

A viewer, as defined herein, is a person that views the instance of the presentation.

A presenter 1 or multiple presenters 1 can use the system to upload presentations 2 to the central computer 9, the central computer 9 putting the presentations 2 in digital storage 6. The presenter 1 can use the presenter console 7 to upload a presentation 2 to the central computer 9. The central computer 9 can then attach a unique ID 11 to the presentation. This ID can take any computer-readable form known in the art. The ID must be different from every other ID already stored in the digital storage 6 so that the system can identify one presentation 2 as corresponding to that unique ID 11.

In one embodiment, multiple presentations 2 can be uploaded to the central computer 9. The multiple presentations 2 can be combined into a composite presentation. The composite presentation can be a presentation made up of the multiple presentations 2. In order to make the composite presentation, any number of the multiple presentations 2 can be combined in a way where the multiple presentations 2 are shown in one composite presentation. When the composite presentation is given by a presenter, the composite presentation can show all of the material in each of the comprising multiple presentations 2 without closing one of the multiple presentations 2 and opening another.

For example, in the one composite presentation, a first one of the multiple presentations can be shown, then consecutively another one of the multiple presentations 2 can be shown. Alternatively, the data from two of the multiple presentations 2 can be combined so that data from one of the multiple presentations 2 is interspersed within the other of the multiple presentations 2. A composite presentation can contain data from any number of multiple presentations 2.

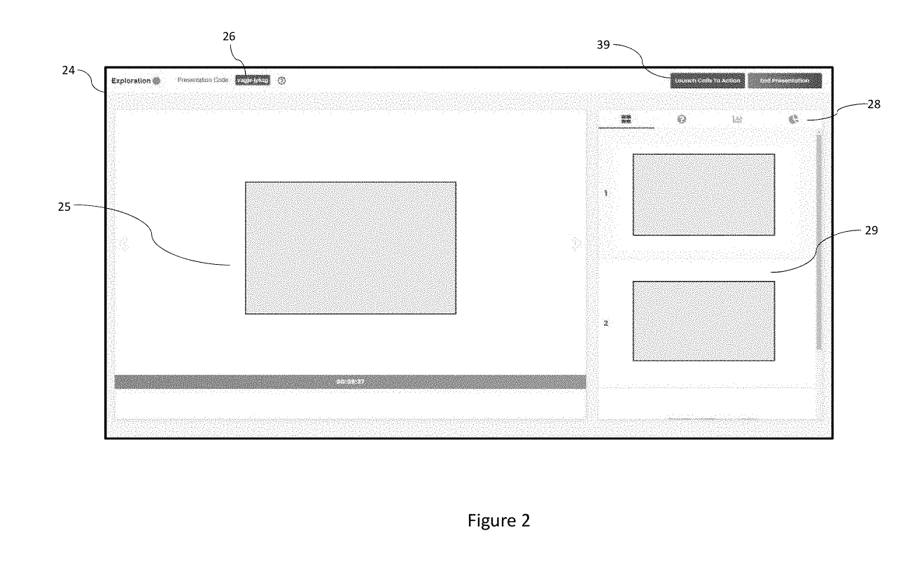

Referring to FIG. 2, the presenter's console 24 can show different information simultaneously or alternatively. It can show the current presentation slide 25, the presentation's unique ID 26, tabs for selecting other information to show 28, and additional slides in the presentation 29. Other tabs 28 can be selected to show poll questions 15, questions received from view computers, and engagement data 14.

A presenter 1 or multiple presenters 1 can use the presentation system to conduct a presentation 2. To use the system, the presenters 1 can interact directly with the central computer 9 or with presenter computers 7 to communicate with the central computer 9 and conduct the presentation 2. The central computer 9 can display the presentation 2 and relevant data, including a presenter console 24, on a central computer display. Additionally, the presenter computers 7 can display the presentation 4 and relevant data, including a presenter console 24, on a presenter computer display.

A presenter computer 7 can switch to a view computer 18 at different points in the presentation 4 depending at least on the functions required of the computer and the role of the user of the computer. For example, a presentation instance can be led by a presenter 1 using a presenter computer 7 and viewed by viewers on view computers 18. At a certain point during the presentation 2, the presenter 1 can concede control of the progression of the presentation instance to a viewer on a view computer 18, the viewer becoming the presenter 1. The new presenter's computer becomes a presenter computer 7 and the former presenter's computer becomes a view computer 18.

The presentations in digital storage 6 can have corresponding IDs 11 unique to each presentation 2 stored in digital storage 6. The view computers 18 can send a unique ID 11 to the central computer 9 to retrieve a presentation 4 associated with the unique ID 11. When the central computer 9 receives a unique ID 11 corresponding to one stored in digital storage 6, the central computer 9 retrieves the presentation associated 4 with the unique ID 11 from the digital storage 6 and sends it to the view computer 18. The view computer 18 then displays the associated presentation on its display 18′.

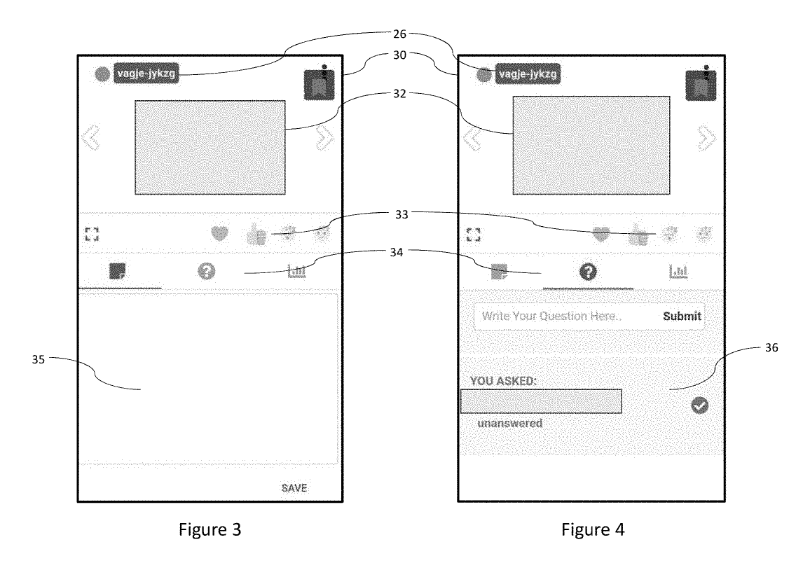

Referring to FIGS. 3 and 4, the view computer 18 can have a user interface. The user interface can display different kinds of information individually and alternatively or simultaneously. The user interface can show the presentation's unique ID 31 and an area with tabs 34 to select what information or sections to show. The user interface can also display the presentation 32 and can simultaneously or alternatively display, poll questions, poll results, calls to action, an area for the user to compose notes 35, an area for the user to compose and send questions to the presenter 36, an area where answers to questions can be displayed 36, and an area 33 where engagement feedback 14 can be entered by the user, and compiled engagement feedback, although is not limited thereto.

Engagement feedback 14 can be input by a user in any form indicating a level of engagement including, but not limited to, selection or input of a numerical value or any other value of a scale ranging from low to high engagement or different types of opinion regarding a presentation. For example, the user interface can display graphical symbols representing the user's opinion of the presentation. The symbols are configured such that a viewer can select one that represents their opinion of the presentation and the system recognizes it as such. These symbols can include, but are not limited to graphical depictions of thumbs up, thumbs down, a smiling face, a sad face, a “snooze” face, an “indifferent” face, an angry face, a frustrated face, a confused face, symbols displaying question marks, symbols commonly known as emojis or any other symbol that represents a possible emotion, opinion, or thought regarding the presentation displayed on the view computer.

The system is designed such that the user can input engagement feedback 14 at any time by selecting the symbol that best represents an opinion of the presentation 4. Engagement feedback 14 intentionally input by the user can be called active engagement feedback. The user can change the active engagement feedback 14 at any time during the presentation 4. This change in feedback is sent to the central computer 9 by the view computer 18. The central computer 9 continuously compiles the active engagement feedback 14 and displays it to the presenter 1, updating the information displayed to the presenter 1 as the feedback 14 is changed and compiled.

The presenter 1 can choose to display the compiled active engagement feedback on the presenter computer 7 and all or some of the view computers 18. The presenter 1 can choose to display a snapshot of active engagement feedback compiled at a particular point in time or real-time updating, compiled active engagement feedback. To display the feedback 14, the presenter can, using the presenter console 7, select a check box, cycle a toggle switch, or input any other action that is commonly known in the art and interpreted by a computer as enabling or disabling a function.

The active engagement feedback 14 from all or some of the view computers 18 can be stored in a database or any digital storage 6 for later review. The active engagement feedback 14 can be recompiled to show the active engagement feedback 14 at any time during or after the presentation 4. The active engagement feedback 14 can also be recompiled to show aggregated engagement for any number of users viewing the presentation 4, including each individual user. An engagement score representing a level of engagement in quantitative terms can be calculated for, but is not limited to, a group of users, multiple groups of users, all users, or each individual user. Engagement scores can be calculated for users or groups of users across multiple presentations and multiple instances of the same presentation or presentations.

The presenter 1 can also transmit poll questions 17 to the view computers 18 using a presenter console 24 on a presenter computer 7 or the central computer 9. The presenter 1 can create the poll questions 17 before the presentation 2 is conducted or while the presentation 4 is being conducted. The poll questions 17 can be created using software on the central computer 9 or the presenter computer 7. The poll questions 17 need not be coupled to a particular presentation 2 or place in a presentation 2. The poll questions 17 can be made completely independent of a presentation 2 and non-exclusively assigned to a presentation 2 or presentation slide at any time, including while a presentation 4 is being conducted. A poll question 17 can be assigned to any number of presentations 2 or presentation slides, or no presentations or presentation slides. A poll question 17 can exist in digital storage 6, uncoupled to any presentation 2 or presentation slide until assigned by a presenter 1.

The answers to polls 17 can be considered active feedback 14, passive feedback 13,15, or other data. The poll answers 15 can be active feedback 14 if they directly give the viewer's opinion of the presentation 4 or any aspect of the presentation 4. The system can also analyze the poll answer 15 and determine the viewer's engagement by the poll question answer 15 if it does not directly give the viewer's opinion of the presentation 2.

Further, the central computer 9 can create poll questions 17 based upon an analysis of the presentation's 4 content using keyword algorithms, Natural Language Processing, and/or Artificial Intelligence methods. The central computer 9 can create poll questions 17 before or while the presentation 4 is conducted. The central computer 9 can then transmit the poll questions 17 to the view computer 18 automatically or ask the presenter 1 for authorization to send the poll questions 17 to the view computers 18.

The view computer 18 can also generate passive feedback 13, 15 by monitoring the user's activity on the view computer 18 while the presentation 2 is being conducted. The view computer 18 can compile and analyze the monitored activity and generate poll questions 17 based upon the monitored activity. Examples of activity the view computer 18 can monitor include, but are not limited to, time spent viewing a presentation 4, time spent viewing a particular slide of a presentation 4, the content of the slides that were viewed the longest, shortest, or for a specific amount of time, questions asked while the presentation 4 is being conducted, the slide viewed while asking a question, the content of notes taken by the user, when those notes were taken, the status of presentation audio while the presentation is being conducted, the kind of feedback 13, 14, 15 offered by the user at a particular time in the presentation 4, direct interaction of the user with the presentation 4, and internet browser activity while the presentation 4 is being conducted. Direct interaction with the presentation 4 can include, but is not limited to, using hyperlinks, watching videos, listening to pre-recorded audio, solving puzzles, answering multiple choice questions, answering polls 17, advancing the presentation slide, and revisiting previous presentation slides.

The presenter 1 can choose to display the compiled passive engagement feedback 13, 15 on all or some of the view computers 18. The presenter 1 can choose to display a snapshot of passive engagement feedback 13, 15 compiled at a particular point in time or real time updating compiled passive engagement feedback. To display the feedback, the presenter 1 can, using the presenter console 24 on the presenter computer 7, select a check box, flip a toggle switch, or input any other action that is commonly interpreted by a computer as enabling or disabling a feature.

The passive engagement feedback 13, 15 can be stored in a database in digital storage 6 for later review. The passive engagement feedback 13, 15 can be recompiled to show the passive engagement feedback 13, 15 at any time during the presentation 4. The passive engagement feedback 13, 15 can also be recompiled to show engagement for any number of users viewing the presentation 4, including each individual user. An engagement score representing a level of engagement in quantitative terms can be calculated for, but is not limited to, a group of users, multiple groups of users, all users, or each individual user. Engagement scores can be calculated for users, or groups of users across multiple presentations and multiple sessions of the same presentation or presentations 4.

Engagement scores can be calculated by weighing active feedback, or passive feedback, or any combination of the two, received corresponding to a user. Examples of the feedback corresponding to a user include, but are not limited to, “likes”, “loves”, bookmarks, notes, poll answers, feedback indicating confusion, feedback indicating boredom, quiz answers, general interactions with the system by a user, view time of a presentation or any part of the presentation, number of slides viewed, or the lack of any of the preceding.

The weight of each feedback type can vary by presentation and can be set in the system by an author, presenter, or by the system using, but not limited to, historical data, preprogrammed algorithms, artificial intelligence methods, or any combination of these methods. Each feedback type can be weighted individually in the calculation of the calculated engagement score 45. Each feedback type can be weighted based on factors including, but not limited to, whether there are polls and quizzes present in the presentation, just polls, just quizzes, or a lack of polls or quizzes. Each feedback type can also be weighted depending on how many slides are present in the presentation.

The system can accept active feedback received from a user for each slide, such as “likes” or “confused” feedback, and compile and analyze it. By way of non-limiting example, the system can use the active feedback to tally a number of points representing the calculated engagement score 45 or for use in calculating the calculated engagement score 45 with other metrics. The system can use historical data, preprogrammed algorithms, artificial intelligence, or any combination of these methods to set the number of points tallied for feedback collected.

By way of non-limiting example, the percentage of slides in a presentation that a user provides a certain feedback can correspond to a certain number of points. For example, if a user marks 1-10% of slides as “liked”, the system can tally one point towards an engagement score. Accordingly, if a user marks 11-20% of slides as “liked”, the system can tally 2 points towards an engagement score, and so on. The number of points tallied for a certain percentage of slides receiving a particular feedback can be set by an author, presenter, or the system.

The foregoing provides an example of a way in which the system can use one active feedback type. The system can use any other active or passive feedback type in a similar fashion.

The system can accept passive feedback received from a user for a presentation, such as how long a user views a presentation or how many notes a user takes, and compile and analyze it. By way of non-limiting example, the system can use passive feedback to tally a number of points representing the calculated engagement score 45 or for use in calculating the calculated engagement score 45 with other metrics. The system can use historical data, preprogrammed algorithms, artificial intelligence, or any combination of these methods to set the number of points tallied for feedback collected.

By way of non-limiting example, the amount of time a user views a presentation with a number of slides can correspond to a certain number of points. For example, if a user views a 10 slide presentation for 10 minutes, the system can tally 1 point towards an engagement score. If a user views the same presentation for 12 minutes, the system can tally 2 points towards an engagement score. The number of points tallied for a time which a user views a presentation can be set by an author, presenter, or the system.

The system can tally points towards a calculated engagement score 45 depending on the percentage completion of a quiz, poll, or other task. The system can tally more points for a calculated engagement score 45 depending on the percentage completion of the quiz, poll, or task.

The system can tally a number of points towards a calculated engagement score 45 depending on how many questions a user asks a presenter. The system can compile more points if more questions are asked. The system can also use natural language processing, preprogrammed algorithms, artificial intelligence, or any combination of these methods to analyze the content of the questions asked and compile and tally a certain amount of points based upon this analysis.

Both active and passive engagement feedback 13, 14, 15 can be used to calculate an engagement score for any of the groups or users in the applications described above.

The central computer 9 can use an engagement score, passive engagement feedback 13, 15, or active engagement feedback 14, or any combination of the preceding, to select a call to action 16 to deliver to the view computer 18. A call to action 16 is a prompt to a user to complete a certain task, usually in regard to the subject matter of the presentation 4. A call to action 16 can be a prompt to, but is not limited to, visit a website, sign up for an email list, submit personal information, submit marketing data, confirm data, confirm that the user is still present at the view computer 18, make a purchase, access an e-commerce platform, make a purchase on an e-commerce platform, submit feedback regarding goods or services on an e-commerce platform, submit feedback regarding an ecommerce website, submit a review of an e-commerce platform, view products and suggested products, sign up for a class, sign up for another presentation, or perform any other action that isn't simply viewing the present presentation 4.

The central computer 9 can select a call 16 to action from a set of pre-drafted calls to action. These calls to action can be created by the presenter 1 or another party. The calls to action can be created independent of a presentation 2 and assigned non-exclusively to any presentation 2 conducted by the central computer. Calls to action 16 can be assigned to a particular slide or a presenter 1 can display a call to action 16 on-demand by using a presenter console on the presenter computer 7. The presenter console can have any number of ways to indicate input from the presenter 1 directing the central computer 9 to send the call to action 16 to a view computer 18. Examples include, but are not limited to, a check box, a flip or toggle switch, or any interactive feature that can recognize an action that is commonly interpreted by a computer as enabling or disabling a feature.

The central computer 9 can also create calls to action 16 by analyzing data associated with the presentation 4 including, but not limited to, the content of the presentation, the active feedback received 14, the passive feedback received 13, 15, past calls to action used by the presenter 1, and the past interaction of users with past calls to action. The central computer 9 can use keyword algorithms, Natural Language Processing, and Artificial Intelligence methods to analyze the data associated with the presentation 2 and create the calls to action 16. The central computer 9 can also use this analysis to determine when during the presentation 4 to transmit the call to action 16 to the view computer 18. The central computer 9 can automatically transmit the call to action 16 to the view computer 18 or it can require authorization from the presenter 1 before transmitting the call to action 16.

The presentation system can select subsequent calls to action based upon the rate and type of interaction with a previous call to action 13. The system can monitor when a user interacts with the call to action 16 and stores different characteristics of this interaction 13 for analysis purposes. Characteristics of the interaction 13 include, but are not limited to, whether the call to action was completed, whether it was viewed, how long it was viewed for, how long it took to complete the action, and whether the action was completed during the presentation instance or scheduled for completion at a later time.

When selecting a subsequent call to action for a particular user, the presentation system can take into consideration characteristics of that user's past interactions with calls to action 13 or past interactions of any other user or group of users. The system can use this information to increase the likelihood of a user to complete a call to action 16 in a timely manner and produce useful information.

The central computer 9 can display questions to the presenter 1 that are representative of multiple questions asked by viewers. The central computer 9 can analyze questions sent to the presenter 1 and determine a common question that the answer to would satisfy multiple viewers, efficiently using the presenter's time in answering questions. The central computer 9 can use a keyword algorithm, Natural Language Processing, Artificial intelligence, or any combination of these to analyze the question asked by viewers and produce a representative question. The representative question is then displayed to the presenter 1 on the presenter console 24 of the presenter computer 7 for the presenter 1 to answer should they choose to.

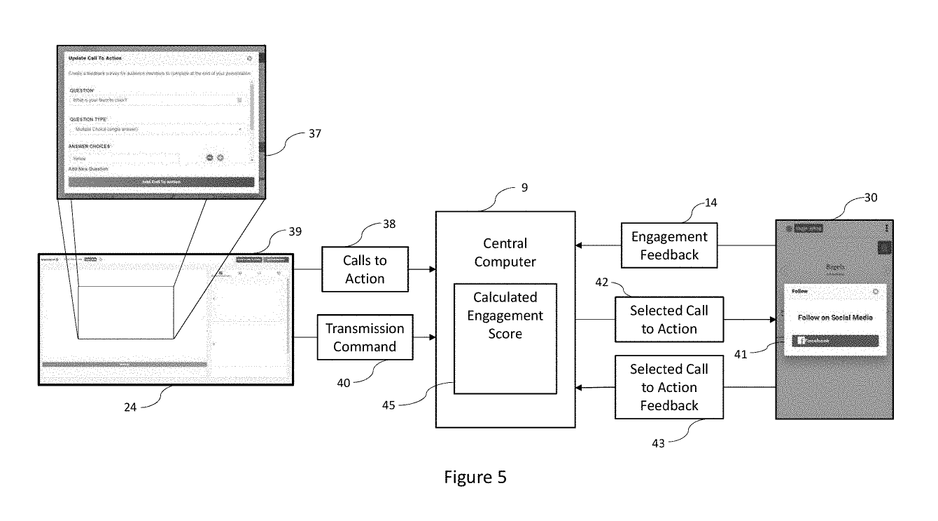

Referring to FIG. 5, an embodiment by which a call to action can be delivered to a viewer interface 30 is shown. First, a call to action is created using a presenter console 24 and a call to action console 37. Using the presenter console 24 and call to action consoles 37, a plurality of calls to action 38 can be created, each individual call to action in the plurality corresponding to a range of calculated engagement scores. The calls to action 38 can then be sent to the central computer 9 from the presenter console 24. The central computer 9 can then store the calls to action 38 in digital storage.

While a presentation is being conducted, a viewer interface 30 can send engagement feedback 14 to the central computer 9. The central computer 9 can use the engagement feedback 14 to calculate a calculated engagement score 45.

A transmission command 40 can then be sent to the central computer 9, by the presenter console 24, using a button 39 on the presenter console 24. The transmission command 40 can direct the central computer 9 to send a selected call to action 42 corresponding with the calculated engagement score 45 to the viewer interface 30. Upon receipt of the selected call to action 42, the viewer interface 30 can display the call to action 41 and allow the call to action 41 to be interacted with by accepting input from a viewer.

The viewer interface 30 can send selected call to action feedback 43 to the central computer 9 once the call to action 41 has been interacted with on the viewer interface 30. The central computer 9 can then use the calculated engagement score 45 or the calculated engagement score 45 in combination with at least the call to action feedback 41 to select subsequent calls to action.

An example of an embodiment method where a call to action is sent to viewer interface 30 is as follows.

A presenter, when giving a presentation, can specify that if a viewer of their presentation is not very engaged with the presentation or has a low engagement score, the viewer will be prompted to fill out a survey seeking information about why the viewer is not engaged with the presentation or some other call to action. Alternatively, the presenter can specify that if the viewer is engaged with the presentation or has a high engagement score, the viewer of their presentation will be prompted to give their email address so that the presenter can market future presentations to the viewer or some other call to action. In order to do this, the presenter can use the embodiment described below.

Some other ways an engagement score or an engagement level can be measured is through accelerometer sensor data, camera data, photosensor data, microphone data, or any other sensor data from the device upon which the viewer interface is executed. Further, data representing interaction with the presentation through the viewer interface can provide data upon which engagement level or score can be determined.

A presenter can interact with a presenter computer having a presenter console 24 and create a plurality of calls to action 38. The presenter or the system can assign multiple calls to action to a range of calculated engagement score ranges associated with a presentation. By way of non-limiting example, all calls to action can be assigned to a calculated engagement score 45 range between 0 and 10. The assigned ranges can overlap or not overlap. Calculated engagement scores 45 in the overlapping ranges can produce multiple call to action selections. A calculated engagement 45 score can be calculated by the central computer 9 and based upon engagement feedback data 14 received from the viewer interface 30. Engagement feedback data 14 can be data where the user of the viewer interface 30 indicates that they like the presentation or they do not like the presentation or any other data known in the art to indicate a user's engagement with a presentation.

The system can assign a call to action to a range of calculated engagement score 45 ranges by use of historical data, preprogrammed algorithms, artificial intelligence, natural language processing, or any combination of these methods.

Users are matched to calls to action by matching their respective calculated engagement scores 45 to predefined call to action score ranges.

The calculated engagement score 45 can be any alphanumeric value. As such, the ranges that calls to action may correspond to can be any range of alphanumeric values corresponding to that of the calculated engagement score 45.

A call to action is a device, usually a dialog box, by which a presenter can prompt a viewer of a presentation to complete a task or otherwise engage a viewer. Examples of a task are signing up for an email list, following a profile on social media, friending a user on social media, taking a survey, visiting a webpage, purchasing a product or service, downloading a file, watching a video, giving a gift, accepting a gift, claiming an item, giving shipping information, playing a game, claiming a coupon, receiving a coupon, or any other action that isn't direct interaction with the presentation instance.

A call to action can have at least an order or suggestion to complete a task contained in a dialog box. In the dialog box, there can also be an internet hyperlink, link to an application or software, an imbedded application, or any other mechanism known in the art to provide a way for a user to complete a task with the view computer from a dialog box.

Following the example above, if a calculated engagement score 45 is calculated to be 4, the corresponding call to action 41 can prompt the user of the view computer to fill out a survey describing why they are not engaged with the presentation. If the calculated engagement score 45 is 7, the corresponding call to action 41 can prompt the user to sign up for an email list to hear more about the topic of the presentation.

While the presenter is giving a presentation, the presenter can click a button on the presenter console 24 which transmits a command to the central computer 9 to consider the calculated engagement score 45 and select the corresponding call to action 41. Continuing with the example above, if the calculated score is 3, then the central computer 9 can send the corresponding call to action 41 to the viewer interface 30 prompting the user to fill out a survey.

The viewer interface 30 can receive the corresponding call to action 41 and display the call to action as a dialog box on the viewer interface 30. The viewer interface 30 can accept input from the user of the viewer interface 30 in order for the user to interact with the corresponding call to action 41. In the above example, the viewer interface 30 would accept input indicating the user's response to the survey questions.

The viewer interface 30 can then send feedback 43 to the central computer 9 indicating whether the user completed the survey, completed a portion of the survey, or took no action regarding the survey. Using this information, the central computer 9 can select future calls to action in addition to the calculated engagement score.

While the present teachings have been described above in terms of specific embodiments, it is to be understood that they are not limited to these disclosed embodiments but can include any combination of the features of the described embodiments. Many modifications and other embodiments will come to mind to those skilled in the art to which this pertains, and which are intended to be and are covered by both this disclosure and the appended claims. It is intended that the scope of the present teachings should be determined by proper interpretation and construction of the appended claims and their legal equivalents, as understood by those of skill in the art relying upon the disclosure in this specification and the attached drawings.

Generally, all terms used in the claims are to be interpreted according to their ordinary meaning in the technical field, unless explicitly defined otherwise herein. All references to a/an/the element, apparatus, component, means, step, etc. are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second,” etc. for different features/components of the present disclosure are only intended to distinguish the features/components from other similar features/components and not to impart any order or hierarchy to the features/components.

To aid the Patent Office and any readers of any patent issued on this application in interpreting the claims appended hereto, Applicant that it does not intend any of the appended claims or claim elements to invoke 35 U.S.C. 112(f) unless the words “means for” or “step for” are explicitly used in the particular claim.

What is claimed is:

1. A presentation system comprising:
a central computer receiving a plurality of presentations from an author, each presentation having a unique identifier;
a database in communication with said central computer for storing each presentation of the plurality of presentations;
a view computer receiving and transmitting one of the unique identifiers to the central computer to retrieve an associated presentation from the database;
a display on the view computer showing the associated presentation to a viewer;
the central computer transmitting a first call to action to the view computer;
the view computer receiving a first call to action, displaying the first call to action, and recording input indicating an interaction with the first call to action;
the central computer receiving the input indicating interaction with the first call to action.

2. The system of claim 1, wherein the call to action is a message prompting a user of the view computer to complete a task using the view computer, the completion of the task providing data to a database.

3. The system of claim 1, wherein the view computer receives a feedback from a user and sends the feedback to the central computer;
the central computer:
receives the feedback;
selects the first call to action to transmit to the view computer based upon at least the feedback from the view computer.

4. The system of claim 3, wherein the feedback is produced by the user answering a feedback poll on the view computer.

5. The system of claim 3, wherein the feedback is produced by an interaction with the view computer, by the user, during the presentation and the feedback is assigned a weight, the weight determining a relative effect the feedback has on the selection of the first call to action.

6. The system of claim 1, the presentation system further comprising:
an interface on the view computer for entering feedback about the associated presentation, the view computer configured to transmit the feedback to the central computer;
the central computer:
receiving the feedback;
storing the feedback on the database together with the associated presentation;
showing the feedback to the author;
determining the first call to action based upon at least the feedback.

7. The system of claim 3, wherein the central computer compiles from a plurality of view computers the feedback, each of the view computers of the plurality of view computers having a separate feedback, and modifies the first call to action.

8. The system of claim 7, wherein the central computer determines an individual first call to action for each of the view computers of the plurality of view computers based upon at least the feedback of each of view computers of the plurality of view computers and transmits each individual first call to action to each view computer.

9. The system of claim 7, wherein the central computer determines an individual first call to action for each of the view computers of the plurality of view computers based upon at least the content of the presentation and transmits each individual first call to action to each view computer.

10. The system of claim 1, wherein the central computer determines a second call to action based upon at least the input indicating an interaction with the first call to action.

11. The system of claim 1, the presentation system further comprising:
a poll received by the central computer from an author, wherein:
the database stores the poll;
the view computer receives the poll;
the display on the view computer shows the poll;
the interface on the view computer accepts a response to the poll;
the view computer transmits the response to the central computer;
the central computer:
associates the poll with one of the unique identifiers;
receives the response;
stores the response together with the associated presentation;
shows the response to the author;
shows the response on the display on the view computer at the command of the author and during the associated presentation;
determines the first call to action based upon at least the response.

12. The system of claim 11, wherein the response updates in real time while shown on the display on the view computer.

13. The system of claim 11, wherein the central computer:
receives a plurality of responses;
stores the plurality of responses together with the associated presentation;
shows the plurality of responses to the author;
shows the plurality of responses on the display on the view computer at the command of the author and during the associated presentation;
determines the first call to action based upon at least the plurality of responses.

14. The system of claim 1, the presentation system wherein:
the plurality of presentations are from at least one author, each presentation of the plurality of presentations being a segment of a composite presentation and having a unique identifier;
the database storing the plurality of presentations;
a presentation computer transmitting the unique identifier to the central computer and for initiating delivery of the segments of the composite presentation to the view computer;
an interface displayed on the display of the view computer for entering feedback about the composite presentation;
the central computer:
receiving the feedback from the view computer, and using at least the feedback to select the next segment of the composite presentation;
showing the feedback to the at least one author;
determining the first call to action based upon the feedback;
transmitting the first call to action to the view computer;
receiving the input indicating interaction with the first call to action.

15. The system of claim 1, wherein the view computer is a mobile phone.

16. The system of claim 14, wherein the central computer compiles the feedback from a plurality of view computers and modifies the call to action based on at least the compiled feedback.

17. The system of claim 1, wherein the author submits a plurality of calls to action to the central computer.

18. The system of claim 17, wherein the central computer selects a first call to action from the plurality of calls to action for each view computer of the plurality of view computers based on at least the feedback from the corresponding individual view computer of the plurality of view computers.

19. The system of claim 3, wherein said feedback is displayed with the associated presentation, on the display of the view computer, in real time.

20. A method by which a call to action is transmitted to a view computer comprising the steps of:
creating a call to action;
a central computer receiving a plurality of calls to action;
the central computer storing the plurality of calls to action in a digital storage;
the central computer receiving engagement feedback from the view computer;
the central computer calculating an engagement score;
the central computer receiving a command to transmit one call to action of the plurality of calls to action, selecting the one call to action based upon the engagement score, and transmitting the selected one call to action to the view computer;
the view computer displaying the selected one call to action on a user interface on the view computer;
the user interface accepting an input interacting with the selected one call to action;
the view computer producing call to action feedback as a result of at least the input;
the view computer transmitting the call to action feedback to the central computer, the central computer storing the call to action feedback in the digital storage;
the central computer transmitting the call to action feedback to the presenter computer, the call to action feedback being displayed on the presenter console.
